(19) United States
(12) Patent Application Publication
(10) Pub. No.: US 2002/0035184 A1
(43) Pub. Date: Mar. 21, 2002

(54) Method of reducing degradation in polymers

(76) Inventors: Deborah E. Plaver, Midland, MI (US); Michael L. Mounts, Midland, MI (US); Patrick M. Russell, Freeland, MI (US); Albert H. Case, Gladwin, MI (US); Michael W. Potts, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/860,096

(22) Filed: May 17, 2001

Related U.S. Application Data
(60) Provisional application No. 60/207,522, filed on May 26, 2000.

(51) Int. Cl. C08K 3/38

(52) U.S. Cl. 524/404; 524/544; 524/557; 524/425; 524/451; 524/430

(57) ABSTRACT

A method for reducing degradation during processing of polymers. An effective amount of a foam cell nucleating agent to reduce degradation in a polymer is added to the polymer. The polymer and the foam cell nucleating agent are mixed to obtain a molten plastic and processed to obtain an unfoamed product, resulting in a reduction of degradation in the unfoamed product. The processing is preferably selected from extrusion and injection molding.

This application claims the benefit of U.S. Provisional Application No. 60/207,522, filed May 26, 2000.

### BACKGROUND OF THE INVENTION

This invention relates generally to reducing degradation in the processing of polymers. More particularly, it relates to a method of reducing degradation during the processing of polymers.

Polymer degradation involves decomposition of the polymer, and it can manifest itself in a variety of ways. Thermal degradation depends on both the temperature to which the polymer is subjected and the length of time the polymer remains at a temperature. Thus, degradation will occur faster at higher temperatures. However, an equivalent amount of degradation can occur if the polymer remains at a lower temperature for a long enough time. In some polymers, degradation can be observed visually by a change in color, such as yellowing in an extruded PVDC. In extreme cases of degradation, carbon (black particles) can be formed. In other polymers, gels, fisheyes, or other physical defects may form, which, given sufficient residence time and temperature, can also form carbon. Degradation is believed to occur when polymer sticks to metal in the system or finds a dead spot with no material movement and degrades excessively. For example, during extrusion of some polymers, carbon forms in the die and along the length of the screw and builds up over time. Eventually, the carbon sloughs off, appearing as black particles in the product. When the physical defects (carbon or other defects) in the product become severe enough, the equipment must be stopped and cleaned out before processing can continue.

All polymers will degrade given a high enough temperature and a long enough time. For many polymers, for example, polystyrene, and styrene acrylonitrile, the extrusion temperatures and residence times in the extruder (or other processing equipment) do not cause noticeable degradation.

However, some polymers are particularly sensitive to thermal degradation. Processing of these thermally sensitive polymers is especially difficult because the extrusion/injection molding temperatures equal or exceed the temperature at which the polymer starts to degrade, and the degradation products are particularly offensive in the finished article. As used in this application, the term “thermally sensitive polymer” means a thermoplastic polymer having an extrusion/injection molding temperature at or above the temperature at which the onset of degradation occurs. Examples of thermally sensitive polymers include, but are not limited to, polyvinyl chloride (PVC) polymers and copolymers, polyvinylidene chloride (PVDC) polymers and copolymers, ethylene vinyl alcohol (EVOH) polymers and copolymers, polyvinyl alcohol (PVA) polymers and copolymers, linear low density polyethylene (LLDPE) polymers and copolymers, metallocene catalyzed polymers and copolymers, ethylene acrylic acid (EAA) polymers and copolymers, and thermoplastic urethane polymers and copolymers.

In the case of PVC and PVDC, the degradation mechanism is the same: dehydrochlorination. During this process, polyenes of various lengths are formed. This causes discoloration which can be seen even at very low concentrations. Degradation causes changes in other polymer properties as well. Furthermore, the presence of the polyenes accelerates the dehydrochlorination in the degradation of the polymer.

With PVDC, degradation begins at about 120° C., melt temperatures are in the range of about 160° C. to 180° C., and extrusion temperatures are in the range of about 170° C. to 190° C. Degradation begins at about 150° C. for PVC, melt temperatures are in the range of 155° C. to 300° C., and extrusion temperatures are in the range of about 165° C. to 310° C.

With polymers such as EVOH, PVA, EAA, LLDPE, metallocene catalyzed polymers and copolymers, and thermoplastic urethane polymers and copolymers, degradation can take the form of gel formation in the product. These gels are believed to be areas of highly crosslinked material. For EVOH, degradation begins at about 180° C., the melt temperature is about 165° C. to 190° C., and the extrusion temperatures are in the range of about 185° C. to 280° C. Degradation begins at about 180° C. for PVA, the melt temperature is greater than 230° C., and the extrusion temperatures are in the range of about 260° C. With LLDPE and metallocene catalyzed polymers, extrusion temperatures are in the range of 204° C. to 288° C. For EAA, extrusion temperatures are in the range of about 190° C. to 310° C., depending on the product being made.

Many processing aids have been used to aid in the extrusion of polymers. For example, U.S. Pat. No. 5,688,457 discloses use of foam cell nucleating agents (without a blowing agent) to increase the extrusion rate of unfoamed thermoplastic polymers. As described in the patent, use of a foam cell nucleating agent, such as boron nitride, permits operation of the extrusion process at a shear rate which is at least 1.2 times the shear rate at which the extrudate normally exhibits gross melt fracture.

However, increasing the extrusion rate of a thermally sensitive polymer such as PVC or PVDC is not desirable. PVDC resin is typically processed on a single screw extruder by shearing the polymer, which generates the majority of the heat for melting the polymer. The barrel of the extruder removes the heat generated by the polymer shearing especially in the solid to melt transition zone. As a result, the actual temperatures of the PVDC can be significantly hotter than the thermocouple readings.

With both coextruded and monolayer PVDC film, there is an optimum processing output range and temperature to minimize degradation. Increasing output rate beyond this optimum rate is not desirable. With a coextruded PVDC film in which PVDC is not in an outer layer, the processing temperatures are dictated by the polymers selected for the outer layers. These temperatures will usually be higher than is desired for processing PVDC. Increasing the output rate would require operating at an even higher die temperature. This would result in more degradation and increased carbon formation in the die.

In addition, higher throughput rates may also result in greater carbon on the screw because of increased shear heating from the higher screw speed needed to increase throughput. Higher throughput may also increase the frequency of carbon showers due to an unstable melt zone.

In a monolayer PVDC film, higher throughput rates will result in more carbon formation, whether the die temperature is raised or not. At the same die temperature, more shear heating will be induced, which increases degradation in the die. Furthermore, increasing the die temperature shortens the time to degradation.

Therefore, there is a need for a method of reducing the amount of degradation which occurs during processing of polymers. This would increase the length of time between shutdowns, thus improving production yields.

### SUMMARY OF THE INVENTION

This need is met by the present invention which provides a method of reducing degradation during processing of polymers.

In a first aspect, the present invention is a method for reducing degradation during processing of a polymer comprising:

providing a polymer;

adding an effective amount of a foam cell nucleating agent to the polymer to reduce degradation of the polymer;

mixing the polymer and the foam cell nucleating agent and

processing the mixture to obtain an unfoamed product,

whereby degradation in the unfoamed product is reduced.

In a second aspect, the present invention is the product produced by the method of the first aspect.

In a third aspect, the present invention is a polymer composition comprising a polymer and an effective amount of a foam cell nucleating agent to reduce degradation of the polymer during thermal processing thereof.

### DETAILED DESCRIPTION OF THE INVENTION

An effective amount of a foam cell nucleating agent to reduce degradation of a polymer is added to the polymer. The polymer and the foam cell nucleating agent are mixed and processed to obtain an unfoamed product, resulting in a reduction of degradation in the unfoamed product. The processing is preferably selected from extrusion and injection molding.

The polymer can be a thermally sensitive polymer. Thermally sensitive polymers are preferably selected from polyvinyl chloride polymers and copolymers, polyvinylidene chloride polymers and copolymers, ethylene vinyl alcohol polymers and copolymers, polyvinyl alcohol polymers and copolymers, linear low density polyethylene, metallocene-catalyzed polymers and copolymers, thermoplastic urethane polymers and copolymers, and mixtures thereof.

The foam cell nucleating agent is preferably selected from boron nitride, calcium carbonate, calcium tetraborate, talc, and metal oxides, and more preferably is boron nitride.

Other foam cell nucleating agents in addition to boron nitride and calcium carbonate which can be used in the practice of the present invention include, but are not limited to, low molecular weight polytetrafluoroethylene (low molecular weight being characterized by a melt fluorinated sulfonic and phosphoric acids and salts disclosed in U.S. Pat. No. 5,023,279, such as TELOMER® B sulfonic acid having the formula F(CF₂)ₙCH₂CH₂SO₃H, wherein n is an integer of 6 to 12. The particular TELOMER® B is identified by the predominant value of the integer “n”, e.g., BAS-10 is the barium salt of the sulfonic acid wherein n=10 as the predominant chain length present. Additional salts include BAS-8, ZrS-10, CrS-10, FeS-10, CeS-10, and CaS-10. For lower melting thermoplastic polymers, hydrocarbon salts of these long chain sulfonic or phosphonic acids can be used, such as BaS-3H (barium propane sulfonate) and KS-1(H) (potassium methane sulfonate). The eight-carbon perfluorinated sulfonic acid available as Fluororad® FC-95, can also be used. Additional foam cell nucleating agents include calcium tetraborate, talc, and metal oxides, such as MgO, Al₂O₃, and SiO₂.

The foam cell nucleating agent is preferably present in an amount of about 5 ppm to about 1000 ppm, more preferably about 5 ppm to about 500 ppm, still more preferably about 5 ppm to about 250 ppm, and most preferably about 5 ppm to about 100 ppm based on the total weight of polymer plus additives. The foam cell nucleating agent preferably has a particle size in the range of from about 5 to about 10 μm.

This method can optionally include heating the polymer while mixing the polymer and the foam cell nucleating agent.

The invention also involves products made by these methods.

The present invention is illustrated in further detail by the following examples. The examples are for the purposes of illustration only, and are not to be construed as limiting the scope of the present invention. All parts and percentages are by weight unless otherwise specifically noted.

### EXAMPLES

The effect of the addition of foam cell nucleating agents on the degradation of polymers was evaluated using several tests.

### Example 1

Preliminary evaluations were done using a two-roll mill. The two-roll mill has two counter-rotating rolls having a diameter of 4.05 inches (10.3 cm) that are heated by hot oil. The gap distance between the rolls can be adjusted from 0.13 mm to 1.3 mm. The temperature was set to 165° C., the roll speed was 13 rpm, and the gap between the rolls was initially set at 0.005 inches (0.13 mm). As the resin melted and fused together, the gap was opened to less than 0.05 inches (1.3 mm). The vent flow valve was maintained at the same position throughout the testing. Two polymers were evaluated: a copolymer of vinylidene chloride and methyl acrylate and a copolymer of vinylidene chloride and vinyl chloride. Dry resin powder was placed between the rolls and it melted as a result of shear and heat. Samples chips were taken at 3 minute intervals starting 3 minutes after the polymer was poured onto the rolls, and the samples were evaluated for stickiness, stiffness, and color at different levels of boron nitride.

The stickiness and stiffness of the samples, which measure differences in the adhesion of the polymer to metal, were rated on a scale of 0 to 5. Stickiness and stiffness relate to the tendency of the polymer to adhere to metal, which could increase the likelihood of degrading the polymer.

The ratings for stickiness are: 0—no sticking on rolls; 1—some sticking on roll (small spots on some parts of the roll); 2—thin film on surface; 3—thin film with thick spots; 4—thick film on roll surface; and 5—extreme case, sticks to everything. The ratings for stiffness are: 0—resin forms one long string when pulled; 1—a couple of strands form, but can be pulled without breaking; 2—many strands form, break after medium distance; 3—many strands form, break after short distance; 4—breaks when pulled very short distance; and 5—almost impossible to pull from the roll.

Table 1 shows the results of the two-roll mill tests for stickiness and stiffness on the copolymer of vinylidene chloride and methyl acrylate.

TABLE 1
Two-Roll Mill - Stickiness and Stiffness
Copolymer of Vinylidene Chloride and Methyl Acrylate

| Time- | 0.01% BN | | 0.05% BN | |
|---|---|---|---|---|
| Minutes | Stickiness | Stiffness | Stickiness | Stiffness |
| 3 | 2 | 2 | 2 | 2 |
| 6 | 2 | 2 | 2 | 2 |
| 9 | 2 | 2 | 2 | 2 |
| 12 | 3 | 2 | 3 | 3 |
| 15 | 3 | 2 | 3 | 3 |
| 18 | 3 | 3 | 3 | 3 |
| 21 | 3 | 4 | 3 | 3 |
| 24 | 3 | 4 | 3 | 3 |
| 27 | 3 | 4 | 3 | 3 |
| 30 | 3 | 4 | 3 | 3 |

The percentages of boron nitride are based on the total weight of the polymer plus any additives (if any).

### Example 2

The color of the samples of the copolymer of vinylidene chloride and methyl acrylate was also evaluated to provide an indication of degradation. The samples were rated on a scale of 1 to 10, where 1 indicates severe degradation and carbon formation and 10 indicates barely noticeable yellowing. The results are shown in Table 2.

TABLE 2
Two-Roll Mill - Color
Copolymer of Vinylidene Chloride and Methyl Acrylate

| Time - Minutes | 0% BN | 0.01% BN | 0.05% BN |
|---|---|---|---|
| 3 | 9 | 9-10 | 9 |
| 30 | 2 | 3 | 5 |

The addition of the boron nitride to the copolymer of vinylidene chloride and methyl acrylate reduced the degradation of the polymer as seen in the improved color after 30 minutes for the samples containing 0.01% boron nitride and 0.05% boron nitride as compared to the sample without it. Furthermore, the addition of the boron nitride also showed decreased stiffness, indicating a reduced tendency to adhere to metal.

### Example 3

The effect of the size of the boron nitride particles was also studied. Three grades of boron nitride from Carborundum Corp. were evaluated: CTF5 (platelet)—mean particle size—5 to 10 μm; CTL40 (low density agglomerate)—screen analysis—40/+140 mesh (90% of the material is in the range of from 102 to 425 μm); and CTH40 (high density agglomerate)—screen analysis—40/+140 mesh (90% of the material is in the range of from 102 to 425 μm). The larger particle size material (CTL40 and CTH40) was very noticeable in a clear 1-2 mil (0.025 to 0.005 cm) thick film. This is not acceptable from an appearance standpoint in many products. Therefore, the smaller particle size material (5 to 10 μm) is preferred.

### Example 4

The addition of boron nitride was also tested on a ¾ inch (1.9 cm) extruder, which is used to screen polymer formulations for thermal stability. The test material was extruded at 40 rpm and a temperature profile of 145° C./155° C./165° C. for the extruder (from back to front) with a die temperature of 175° C. After two hours of run time, full cooling was applied to the extruder. The die heel was then examined. The die heel is the cooled polymer remaining in the die when the extruder is cooled as quickly as possible and taken apart while the material is still molten enough to separate the die from the extruder. The amount of carbon in the die heel was visually assessed, and the samples were ranked in order from the least amount of carbon formed to the most. Table 3 shows the results of the ¾ inch (1.9 cm) extruder experiment.

TABLE 3
¾ -Inch Extruder - Carbon Formation Ranking

| | |
|---|---|
| 1. | Copolymer of vinylidene chloride and methyl acrylate - 0.05% BN |
| 2. | Copolymer of vinylidene chloride and methyl acrylate - 0.01% BN |
| 3. | Copolymer of vinylidene chloride and methyl acrylate - 0.00% BN |
| | (Control) |
| 4. | Copolymer of vinylidene chloride and vinyl chloride - 0.05% BN |
| 5. | Copolymer of vinylidene chloride and vinyl chloride - 0.00% BN |
| | (Control) |

Improvement in the amount of carbon formation was seen with 0.01% BN and with 0.05% BN for the copolymer of vinylidene chloride and methyl acrylate as compared to the control without any BN. For the copolymer of vinylidene chloride and vinyl chloride, the 0.05% BN showed improvement over the control without BN.

### Example 5

To confirm the improvements in carbon formation, additional tests were run on a 2½ inch (6.35 cm) extruder, which more closely approximates actual production conditions. Samples were run for nine hours on the 2½ inch (6.35 cm) extruder with a temperature profile of 150° C./155° C./160° C./175° C. and a die temperature of 178° C. The output rate for each sample was maintained at 50 lbs./hour (23 kg/hr) by adjusting the rpm of the screw. The extrusion barrel and die were then cooled as quickly as possible. The heels from the screw and the die were removed and visually ranked for carbon formation from least to most. Table 4 shows the results of this testing.

TABLE 4
2½ Inch Extruder - Carbon Formation Ranking

| | |
|---|---|
| 1. | Copolymer of vinylidene chloride and methyl acrylate - 0.05% BN |
| 2. | Copolymer of vinylidene chloride and methyl acrylate - 0.005% BN |
| 3. | Copolymer of vinylidene chloride and methyl acrylate - 0.05% |
| | CaCO₃ |
| 4. | Copolymer of vinylidene chloride and methyl acrylate - 0.00% BN |
| | (Control) |

There was significant improvement in carbon formation for both the 0.05% BN and the 0.005% BN samples as compared to the control. The 0.05% CaCO₃ sample (10 μm particle size, which matches the size of the preferred boron nitride particles) showed some improvement over the control, but not as much as 0.005% EN. The significant improvement produced with 0.005% BN suggests that lower levels of BN would also provide reduced carbon generation.

It is desirable to add as little boron nitride as possible due to the cost of this processing aid. In addition, the upper limit of the boron nitride is governed by an unacceptable amount of die slough. When too much boron nitride is used in a monolayer PVDC product, it sloughs off at the die, which can cause problems in processing products such as film. The die slough at 500 ppm was noticeably worse than at 50 ppm, but it was not unacceptable. The lower limit is that amount of boron nitride which provides a reduction in the degradation of the polymer. The preferred range is between about 5 and 1000 ppm, more preferably between about 5 and 500 ppm, still more preferably between about 5 and 250 ppm, most preferably between about 5 and 100 ppm based on the total weight of polymer plus additives.

The decrease in degradation and carbon formation was found at normal operating conditions. The output rate was not increased.

The extrusion was performed at a shear rate which is less than one times the shear rate at which the onset of surface roughness occurs in the product in the absence of the boron nitride. This shear rate can be determined for a particular polymer by increasing the speed of the processing machine, an extruder for example, until surface roughness appears in the product. The shear rate to be used would be less than the shear rate at which surface roughness begins. Surface roughness is undesirable in certain applications because it causes problems in the product, such as haze in a film.

Without being limited to theory, it is believed that the foam cell nucleating agent forms an interface between the metal and the melt, preventing buildup and thus carbon formation.

### Example 6

An experiment was conducted to determine the impact of particle size on the effectiveness of boron nitride as an extrusion aid to reduce degradation of thermally sensitive polymers. For this experiment, a copolymer of vinylidene chloride and methyl acrylate was formulated with standard processing aids and 0.05% boron nitride powder. One formulation contained a boron nitride powder that had a particle size of 5 to 10 microns (Carborundum's “CTF5 ” small particle size boron nitride), while the other formulation contained a boron nitride powder that had a particle size of 105 to 420 microns (Carborundum's “CTH or CTL 40” large particle size boron nitride). Both formulations were extruded on an Egan 2-½ inch extruder with an annular die for 9 hours. During the extrusion, the extruder rpm was set to achieve a rate of 49 pounds per hour. In the case of the small particle size boron nitride, a screw speed of approximately 16 rpm was required to achieve this rate, while a screw speed of approximately 17 rpm was required to achieve this rate for the large particle size boron nitride. Also, it was observed that the small particle size boron nitride resulted in lower extrusion pressures and amperage as compared to the large particle size boron nitride.

At the end of the extrusion runs, the extruder was “crash cooled” by turning off the drive motor, and applying full cooling to extruder barrel and die in order to freeze the melt stream. Then, the die was disassembled and the screw was removed from the extruder and the frozen melt streams (screw and die “heels”) were visually inspected. It was determined that there was significantly more carbon on both the screw and die heels from the run with the formulation containing the large particle size boron nitride. In addition, the large particle size boron nitride resulted in noticeable white particulate in the extrudate. This work confirms that smaller particle size boron nitride is both more effective in reducing the degradation of thermally sensitive polymers during extrusion and is a prerequisite in producing attractive transparent product.

While certain representative embodiments and details have been shown for purposes of illustrating the invention, it will be apparent to those skilled in the art that various changes in the compositions and methods disclosed herein may be made without departing from the scope of the invention, which is defined in the appended claims.

What is claimed is:

1. A method for processing a polymer comprising:
providing a polymer;
adding an effective amount of a foam cell nucleating agent to the polymer to reduce degradation of the polymer, carbon formation or gel formation during processing of the polymer;
mixing the polymer and the foam cell nucleating agent and
processing the mixture to obtain an unfoamed product,
whereby degradation in the unfoamed product, gel formation or carbon formation is reduced.

2. The method of claim 1 further comprising heating the polymer while mixing the polymer and the foam cell nucleating agent.

3. The method of claim 1 wherein the polymer is a thermally sensitive polymer.

4. The method of claim 1 wherein the thermally sensitive polymer is selected from polyvinyl chloride polymers and copolymers, polyvinylidene chloride polymers and copolymers, ethylene vinyl alcohol polymers and copolymers, polyvinyl alcohol polymers and copolymers, linear low density polyethylene polymers and copolymers, metallocene catalyzed polymers and copolymers, ethylene acrylic acid polymer and copolymers, and thermoplastic urethane polymers and copolymers, and mixtures thereof.

5. The method of claim 4 wherein the thermally sensitive polymer is polyvinyl chloride polymers and copolymers.

6. The method of claim 4 wherein the thermally sensitive polymer is polyvinylidene chloride polymers and copolymers.

7. The method of claim 4 wherein the thermally sensitive polymer is ethylene vinyl alcohol containing polymers and copolymers.

8. The method of claim 4 wherein the thermally sensitive polymer is polyvinyl alcohol polymers and copolymers.

9. The method of claim 1 wherein the foam cell nucleating agent is selected from boron nitride, calcium carbonate, calcium tetraborate, talc, and metal oxides.

10. The method of claim 9 wherein the foam cell nucleating agent is boron nitride.

11. The method of claim 1 wherein the foam cell nucleating agent has a particle size in the range of from about 5 to about 10 μm.

12. The method of claim 1 wherein the foam cell nucleating agent is present in an amount of about 5 ppm to about 1000 ppm based on the total weight of polymer plus additives.

13. The method of claim 1 wherein the foam cell nucleating agent is present in an amount of about 5 ppm to about 100 ppm based on the total weight of polymer plus additives.

14. The method of claim 1 wherein the processing is selected from extrusion and injection molding.

15. The method of claim 1 wherein the processing is performed at a shear rate which is less than one times the shear rate at which the onset of surface roughness occurs for the product in the absence of the foam cell nucleating agent.

16. A polymer composition comprising a polymer and an effective amount of a foam cell nucleating agent to reduce degradation of the polymer during thermal processing.
